(19) United States
(12) Patent Application Publication
(10) Pub. No.: US 2002/0087447 A1
(43) Pub. Date: Jul. 4, 2002

(54) System and method for managing and executing event based investments

(75) Inventors: Roy K. McDonald, San Mateo, CA (US); David B. Winterburn, Incline Village, NV (US)

Correspondence Address: PENNIE & EDMONDS LLP, COUNSELORS AT LAW, 3300 Hillview Avenue, Palo Alto, CA, 94304, US

(73) Assignee: Gazebo Inc.

(21) Appl. No.: 09/957,556

(22) Filed: Sep. 19, 2001

Related U.S. Application Data
(60) Provisional application No. 60/234,244, filed on Sep. 19, 2000.

(51) Int. Cl. G06F 17/60

(52) U.S. Cl. 705/36

(57) ABSTRACT

One aspect of the present invention is a method of event-based investing in which a portfolio of securities having a value that is expected to vary in accordance with possible outcomes of a specific event is established. Buy orders and sell orders for units of the portfolio are received. The buy and sell orders of the portfolio are pooled to determine a net number of portfolio units to be bought or sold, and then purchase or sale of a set of securities corresponding to the net number of portfolio units is initiated. Another aspect of the present invention is a server system for managing and executing event based investments. The server system includes first, second and third sets of servers, with communications to the second set of servers being guarded by a first firewall and communications to the third set of servers being guarded by a second firewall. The first set of servers exchange messages with client computers, including receiving buy orders and sell orders for units of a defined portfolio of securities. The second set of servers receive messages from the first set of servers and integrate database information with the messages from the first set of servers. The third set of servers performs financial transactions in accordance with the buy and sell orders.

This applicaiton claims priority on U.S. provisional patent application 60/234,244, filed Sep. 19, 2000, which is hereby incorporated by reference in its entirety.

The present invention relates generally to a system and method for managing and executing financial investments whose performance is tied to defined events, and particularly to a such a system and method for handling investment transactions in event based investment portfolios where each portfolio is designed to change in accordance with the outcome of a specific respective event.

### BACKGROUND OF THE INVENTION

Investment portfolios typically contain investments in numerous securities, each of which may change in value due to a wide variety of factors. In general, investments in securities change in value based on the market price of those securities.

A betting pool is a pool of money contributed by various players, where the payout from the pool is based on the outcome of an event, such as a sporting event. The event that determines the payout from the pool, however, can be virtually any event, such as the performance of a stock index over a specific period of time, the performance of an individual security over a specific period of time, and so on. One factor that distinguishes a betting pool from a “true investment” is that a betting pool is a zero sum exercise, with gains and losses exactly balancing each other.

In a true investment, the return on the investment is based on market forces and the net gain or loss by all the investors who invest through a particular brokerage firm or other investment or financial services company is not a zero sum. That is, the financial services company does not need to balance gains by some investors with losses by others. Rather, return on investment for each investor depends solely on changes in value of the underlying securities in which the investors are investing.

The event based investments that are the subject of the present invention are true investments, as opposed to a betting pool type of “investment.” The performance of each event based investment depends solely on the performance of the underlying securities and does not depend on how much other investors may invest on the opposite side the same investment. All the investors making identical investments in any particular event based investment will enjoy the same gain or suffer the same loss as the other investors. Unlike horse rases and other gambling activities, the return on investment is independent of the investment decisions of the other investors, except to the extent that such other investments may move the overall market in the underlying securities.

Another characteristic of the event based investments of the present invention that makes them distinct from most other types of investments is that these investments have a well defined investment buy and sell dates and times. That is, not only is the time of the initial investment fixed, but the date and time that the investment is liquidated is also fixed. The event based investments are thus “self-liquidating.” Furthermore, many event based investments are very short term investments, having a duration of a day or two. While bonds also typically have fixed issuance and termination or liquidation dates, the value of the bond contract at the termination date is also fixed, while the value at termination of event based investments is generally highly volatile and is thus anything but fixed.

A concern with any investment management and execution system is security. It is imperative that the confidential information of the investors, and the investments themselves, be extremely secure from attack. In systems where investors submit investment orders through an Internet interface, the need for security is especially high.

### SUMMARY OF THE INVENTION

In summary, one aspect of the present invention is a method of event based investing in which a portfolio of securities having a value that is expected to vary in accordance with possible outcomes of a specific event is established. Buy orders and sell orders for units of the portfolio are received. The buy and sell orders of the portfolio are pooled to determine a net number of portfolio units to be bought or sold, and then purchase or sale of a set of securities corresponding to the net number of portfolio units is initiated.

In one embodiment, prior to receiving the buy and sell orders, an investment commitment date and an investment liquidation date is associated with the specific event. The receiving of buy and sell orders is stopped and the initiating of the purchase or sale of securities is performed at a time associated with the investment commitment date. Liquidation of the set of securities is automatically initiated at a time associated with the investment liquidation date, and investment gains and losses are allocated to the buy and sell orders.

Another aspect of the present invention is a server system for managing and executing event based investments. The server system includes first, second and third sets of servers, with communications to the second set of servers being guarded by a first firewall and communications to the third set of servers being guarded by a second firewall. The first set of servers exchange messages with client computers, including receiving buy orders and sell orders for units of a defined portfolio of securities. The second set of servers receive messages from the first set of servers and integrate database information with the messages from the first set of servers. The first firewall limits access between said first set of servers and the second set of servers such that each server in the second set of servers can receive messages from only one corresponding server in the first set of servers. The set of commands from the first set of servers that are accepted by the second set of servers is also highly restricted for security purposes. The third set of servers performs financial transactions in accordance with the buy and sell orders. The second firewall limits access between the second set of servers and the third set of servers so as to permit the third set of servers to receive only predefined requests, and to receive the predefined requests only from the third set of servers.

In one embodiment, the messages exchanged between the first and second sets of servers are encrypted using a first set of encryption keys, and messages exchanged between the second and third sets of servers are encrypted using a second set of encryption keys distinct from the first set of encryption keys. The first and second set of encryption keys may be embedded in hardware within the first, second and third sets of servers so as to be inaccessible to application programs executing on the first, second and third sets of servers.

### BRIEF DESCRIPTION OF THE DRAWINGS

Additional objects and features of the invention will be more readily apparent from the following detailed description and appended claims when taken in conjunction with the drawings, in which:

FIG. 1 is a block diagram of a distributed computer system for managing and executing event based investments.

FIG. 2 is a block diagram of a web server of the system shown in FIG. 1.

FIG. 3 is a block diagram of a session server of the system shown in FIG. 1.

FIG. 4 is a block diagram of an event server of the system shown in FIG. 1.

FIG. 5 is a block diagram of a user server of the system shown in FIG. 1.

FIG. 6 is a block diagram of a web asset server of the system shown in FIG. 1.

FIG. 7 is a block diagram of a transaction server of the system shown in FIG. 1.

FIG. 8 is a block diagram of an archive server of the system shown in FIG. 1.

FIG. 9 depicts a flow chart of a method of the present invention.

### DESCRIPTION OF THE PREFERRED EMBODIMENTS

The present invention is an event based trading system based upon publically traded securities. Users (also herein called customers or investors) invest in the marketplace based upon the user predicted outcome of an event. It is an object of the present invention to make available to investors investments whose performance is highly sensitive to the outcomes of specific events. Each event based investment is either a portfolio of publically traded securities, or a derivative contract (hereinafter called a derivative) based on a portfolio of publically traded securities. In some cases, the portfolio consists of a single publically traded security or a derivative based on that security.

The investment payout is based upon the value of the investment after an associated event has occurred. Therefore, the user is able to invest according to his or her determination regarding the effect of the occurrence or nonoccurrence of a specified event on the marketplace. The event associated with each event based investment is herein called the principal event associated with the investment, often simply called the “associated event.” Events other than the principal event that may affect the value of the investment are herein called secondary events.

Event Based Investments

For investments made using the system of the present invention, the return on each investment (also called the payout) is not based on what is invested by other investors; rather the payout is based on the value of the underlying securities (i.e., the securities in which the investment is made) at the event close. For a particular investor, the value is the same regardless of how many other investors there are or what investments they make, except to the extent that such investments may affect the prices of the underlying securities. Middleman fees are transparent to the investor.

While so-called “day trading” is making very short term investments based on perceived “momentum” in the market, sometimes called “momentum investing,” event-based trading is primary based on changes in momentum (i.e., changes in the price trends of various securities) that are attributable to occurrence or non-occurrence of specific events.

Investment Buy Date and Investment Sell/completion Date

For each investment, there will be an Investment buy date and time, and an investment sale or completion date and time. The investment buy date will almost always be a specific date, typically one or two days before the anticipated event, assuming the date of the anticipated event is known. In this way the investment is made at one time for all investors participating in the particular event based investment. The investment sale date is typically the date on which the event occurs, or a specific number of days or hours after the occurrence of the event. Typically, the date of event will be known in advance and thus the investor will know the date on which the investment will be automatically liquidated. The investment sale date may be specified to be a specific amount of time after the news event in order to give the market time to react to the news event.

When the investment sale date is unknown, because the date of the respective event is uncertain, the investment will be made a specified date determined by the administrators of the system to be before the expected date of the event, and the investment close date will be defined to be a certain number of days and/or hours after the occurrence of the event. If it is uncertain that the event will occur at all, then a limit date will typically be associated with the event close date, in which case the investment will be liquidated on the limit date if the event has not yet occurred by then.

Exclusion of Illegal Event Based Investments

Generally, event based investments will not be based on events, such as sporting events, where the investment would be illegal under applicable law or considered to be immoral by a significant portion of the relevant community.

Portfolio

In most of the examples given below, the investment portfolio for a specific event based investment will be a derivative contract based on a predefined portfolio of securities, such as the common stocks of a predefined group of companies. In most cases, the derivative is designed to change in value by N times as much as the change in value of the underlying set of securities, with a maximum change in value of plus or minus Z%. N will generally be a value between two and twenty, with values between five and ten being preferred. The larger the value of N, the more volatile the investment. Z will typically be a value between 25 and 100, with values between 50 and 100 being preferred. In some embodiments, the maximum percentage of downside risk may not match the maximum percentage of upside gain; thus the investment portfolio may be a derivative where the maximum loss to the investor is Z1% and the maximum gain is Z2%. The company providing the investment service may need to charge a higher management premium for event based investments where the maximum downside and upside change in value are not equal.

In another variation, the derivative contract for a particular event based investment may include insurance against a distinct secondary event having a significant affect on the value of the portfolio. For instance, if the derivative contract is based on the value of a company's stock, the price of which is expected to vary depending on the company's quarterly profit report (which constitutes the primary associated event for the investment), the insurance component of the derivative might protect against swings in the price of the company's stock caused by “acts of God” such as natural events, accidents, the loss of a key executive due to death, injury or illness, and other such secondary events.

In order to simplify the description below of the examples of event based investments, the investment portfolio for each example will be described only with respect to the underlying securities. It is to be understood that in each case, the actual investment portfolio will may be a derivative contract based on the underlying securities, as described above.

Use of Event Based Investments as Hedges

Event based investments can be used by investors as a hedge against changes in other portions of the investor's investment portfolio. For instance, if an investor is concerned that the outcome of an election or some other event such as a change in the CPI will adversely affect the investor's investment portfolio, the investor may buy an event based investment to try to neutralize or diminish the affect of the event on the value of the investment portfolio. The short time duration of many event based investments makes them ideal for isolating a particular risk and providing a hedge against that particular risk.

Examples of Events and Corresponding Investment Portfolios

### Example 1

Type of Event: General financial news event.

Event: An upcoming report on the change in the Consumer price Index (CPI) event during a specified time period (e.g., the most recently ended calendar quarter).

Choice to be made by investor: Yes or No: Will the change in the CPI be greater than X%, where X% is the change in the CPI during the previous quarter. Alternately, X% may be the consensus value predicted by a specified group of people, such as a specified group of economists. Alternately, the choice may be stated differently, such as “Up or Down: Will the reported change in the CPI cause bank stocks to go up or down?”

Portfolio: A derivative based on a predefined portfolio of securities, such as the common stocks of a predefined group of financial institutions (e.g., banks). Another example of a suitable portfolio for this type of event might be a derivative based on the value of a particular type of corporate or government bond, or a derivative based on the value of a particular group of bonds, whose price is sensitive to changes in prevailing interest rates.

### Example 2

Type of Event: Issuance of a report indicating the financial performance of a specific company or a specific set of companies.

Event: A report that will be released reporting the sales and income of a specific company.

Choice to be made by investor: Yes or No: will the report be viewed favorably or unfavorably by the market?

Portfolio: A derivative based on the common stock of the specific company, or the corporate bonds issued by the company.

An other example of this type of event would an event based on the performance of an identified portfolio that reflects the market perceived value of a group of companies, such as a portfolio of bank stocks, or oil company stocks, or computer company stocks, or a specific set of “large capitalization” company stocks, and so on. An example of this type might be the performance of stock on the day of its initial public offering (IPO).

Another example of this general type of an event is the success or failure, or degree of success of failure, of a particular project or product of a specific company or set of companies. Some of these types of events will occur at a date known in advance, while others may have an uncertain completion date.

### Example 3

Type of Event: Clash of the titans.

Event: A comparison of the investment performance of two particular companies, such as Compaq and Dell.

Choice to be made by investor: A or B: will the stock of company A or the stock of company B do better during the specified time period.

Portfolio: A derivative based on going long on the common stock of one of the two companies and going short on the other, with a predefined amount of leverage. For instance, the payout may be based on a predefined multiple of how much more X dollars invested in company A at the beginning of the investment period is worth at the end of the investment period than X dollars invested in company B at the beginning of the same investment period.

Other examples of Clash of the Titans type of events: the relative performance in ticket sales of two movies during a specific period of time or during two respective periods of time (e.g., the first week of release of each movie); the relative performance of two financial indices, such as the Dow Jones Industrial Average and the S&P 500, or any other pair of such indices.

### Example 4

Type of Event: General news event, such a political news event.

Event: The outcome of a political election.

Choice to be made by investor: A or B: will the winner of the election be candidate A or candidate B?

Portfolio: A derivative based on a portfolio of securities believed to be sensitive to the outcome of the election. For instance, one candidate might be known to be more favorably disposed to programs that would benefit a particular industry, such as oil companies, or pharmaceutical companies, and thus a portfolio based on the securities of such companies could be used as an event based investment. As another example, one of the two candidates might be known to be more favorably disposed to programs that would benefit a first particular industry and less favorably disposed to programs that would benefit a second particular industry. In this example the portfolio might be based on a differential between the performance of stocks of companies in the first industry and stocks of companies in the second industry.

### Example 5

Type of event: Financial performance or popularity of a particular movie, TV program, or a defined group thereof (e.g., movies released during a specific week or other specified period of time).

Event: Release of report indicating the dollar amount of ticket sales for a particular movie during the first weekend after its release.

Choice to be made by investor: Yes or No: will the ticket sales exceed a specified level?

Investment: Derivative based on the stock of the movie studio releasing the movie, leveraged so that the change in value of the investment is N times as great as the change in the stock of the movie studio, with a maximum change in value of plus or minus Z% (e.g., 25%, 50% or 100%).

Another example of an event of this general type is the launch of a rocket, such a rocket containing a communications satellite. The portfolio of the event based investment in this example might be based on the stock of the company or companies whose financial performance is dependent on the rocket launch being successful.

### Example 6

Type of event: News event whose completion date is uncertain.

Event: The conclusion or not of merger negotiations between companies A and B.

Choice to be made by investor: Yes or No. Will companies A and B enter into a merger/acquisition agreement?

Investment: Derivative based on the stock of one or both of the companies.

Other examples of events whose outcome date is uncertain, and thus whose associated investment completion date is uncertain, include events such as OPEC meetings, negotiations between warring nations or other groups, the completion of a particular project such a public works construction project, and whether or not a particular piece of legislation will be passed by the United States Congress, a State Legislature or any other governing body, such as the legislature of any particular country or political unit of a particular country.

### Example 7

Type of event: Financial performance of a particular company or product, or the performance of a particular company's stock.

Event: The performance of the particular stock, product or company within a defined period of time (which corresponds to the investment period).

Choice to be made by investor: Yes or No. Will the value of the particular company or the performance of a particular product improve during the defined period of time?

Investment: Derivative based on the stock of the company or companies associated with the event.

An event of this general type might include the performance of a stock of a particular company which has gone up, or down, for X consecutive days. The choice to be made by the investor is whether or not the aforementioned trend will continue for an additional day.

Description of Investment Management System

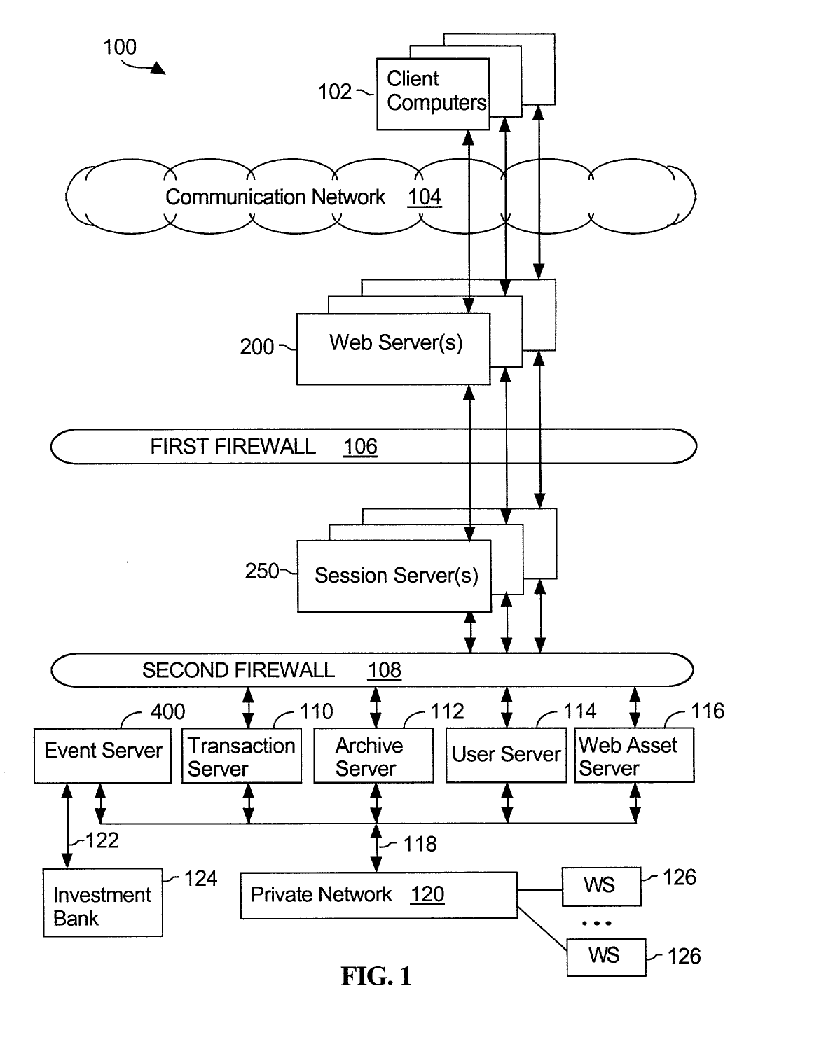

Referring to FIGS. 1-9, there is shown a distributed computer system 100 for managing and executing event based investments. The distributed system includes client computers 102 that communicate with a set of M web servers 200 via a communication network 104, such as the Internet. The web servers 200 sole role is to act as an intermediary between the client computers and a set of session servers 250. In one embodiment there are M session servers 250, equal in number to the web servers 200, with each web server communicating with only one of session servers via a first firewall 106. The first firewall 106 is configured so that each session server accepts requests from only one of the web servers and from no other devices. The functionality of the firewalls 106, 108 is described in more detail below.

The web servers 200 retain no client information other than pages composed by the session servers 250 for the purpose of communicating with client computers who have logged onto the system as registered customers of the system. However, the web servers 200 preferably cache static web pages, primarily informational pages that are not customer specific, so as to decrease communication traffic between the web servers 200 and the session servers 250.

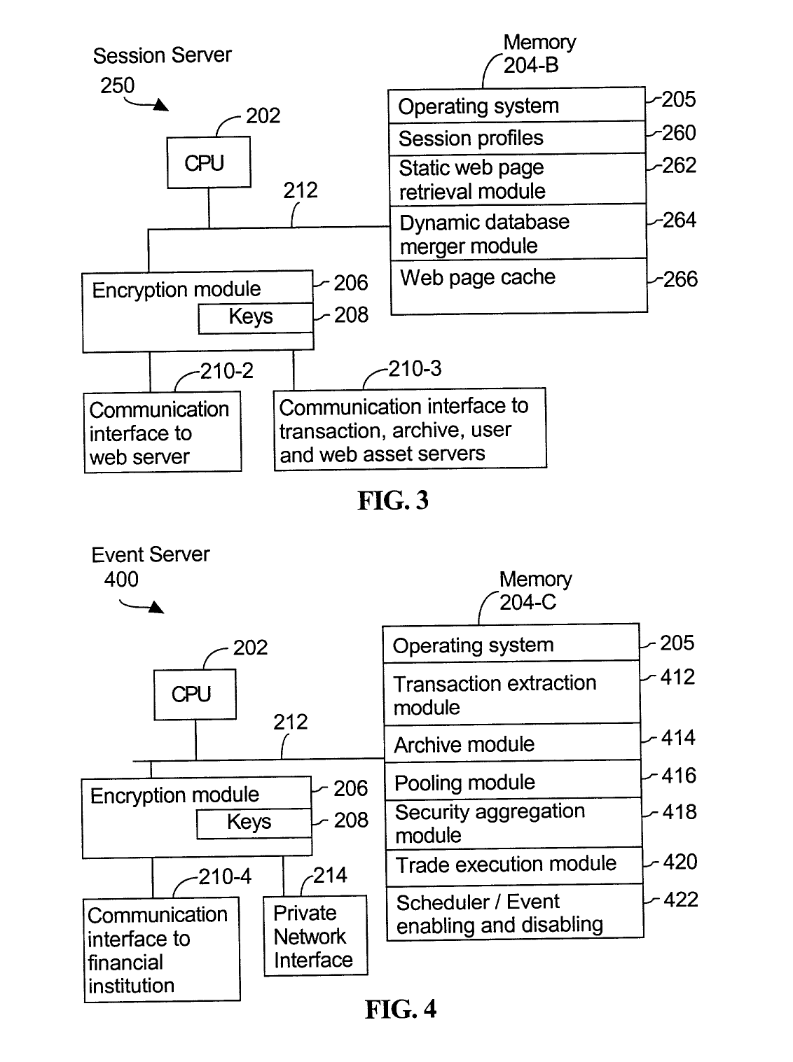

The session servers 250 also retain little client information. In particular, the session server maintains a session profile 260 (FIG. 3) for each customer logged into the system, where the session profile 260 typically includes the current state of the customer's “shopping cart” of investments that the customer has selected, but has not yet submitted as orders, a session key assigned to the “session” (i.e., communications) between the web server and the session server in response to commands by the customer, and information about the most recent web pages composed by the session server for the customer during the current session. The session server retains no client information other than the information in the session profiles, and thus very little private information could be obtained if a session server were compromised.

The session servers 250 communicate with a third layer of servers 110, 112, 114, 116, 400 via a second firewall 108. The third layer of servers comprise the “back office” of the system and contain all customer private information, and perform all investment transactions. These servers include a transaction server 110, which captures and stores all transactions received from customers during a given period of time, such as the current day. One type of transactions stored by the transaction server is investment orders by customers. Investment orders are submitted to the transaction server when a customer submits the investment items in the customer's shopping cart as an investment order. A primary purpose of the transaction server 110 is to separate the function of receiving and storing investment orders from the task of executing investments by submitting investment orders to a financial institution 124, such as brokerage firm or investment bank. The transaction server 110 is configured to be able to handle a very high volume of transactions during short periods of time, such as just before the close of the time period during which investment orders will be accepted during each trading day. The transaction server 110 is the sole source of investment orders that are conveyed to the event server 400 for execution.

The event server 400 executes investments, and is also responsible for certain tasks such as marking which investments are to be made available to customers. The event server 400 communicates with one or more financial institutions 124 via a private communication line 122. Communications over the private line are encrypted so as to prevent eavesdropping and injection of fallacious instructions or data.

An archive server 112 maintains a record of all transactions performed by the system for each customer account. In this context, the term “transaction” means an internal or system level transaction, as opposed to a customer level transaction. There will typically be several system level transactions for each customer level transaction, including: receive and store customer order in transaction server, convey order to event server, placement of order with financial institution, receive investment outcome from financial institution, settle customer account based on investment outcome. The exact set of system level transactions that correspond to each customer level transaction may vary from one implementation to another.

The archive server 112 furthermore stores copies of the definitions of all the event based investments ever ordered by customers, and customer account information sufficient to enable the status of each customer account to be regenerated for any specified date at which the account was in existence.

The user server 114 stores user (i.e., customer) specific data that is long term, such as the name, address, financial history, account balances, and user preferences (e.g., preferences dictating how account information or investment information is to be presented to the customer).

The web asset server 116 stores static web pages, such as forms, information pages and the like, for retrieval by the session servers. The web asset server 116 also stores the definitions of all the available event based investments, including the text explaining the event, the choice to be made by the investor, the investment portfolio, risk management information, and so on.

The session servers 250 populate fields in the web forms obtained from the web asset server 116 with user information retrieved from the user server 114, event based investment information from the web asset server, and shopping cart and other session related information from data stored within the session servers 250, and then sends the populated forms to the web servers 200 for viewing by customers. In addition, the session servers extract customer entered information from web forms so as to determine what information is being requested and what orders are being placed by customers. When the extracted information indicates addition information being requested by the customer, the session server executes the customer's request by obtaining the requested information and constructing a web page that contains the requested information. The session server furthermore is charged with denying improper requests by customers, such as information about accounts not belonging to the customer making the request. When the information extracted by the session server from a form indicates that the customer is submitting one or more investment orders, for instance by confirming the contents of the user's shopping cart, the investment orders are conveyed by the session server 250 to the transaction server 110.

Descriptions of Servers

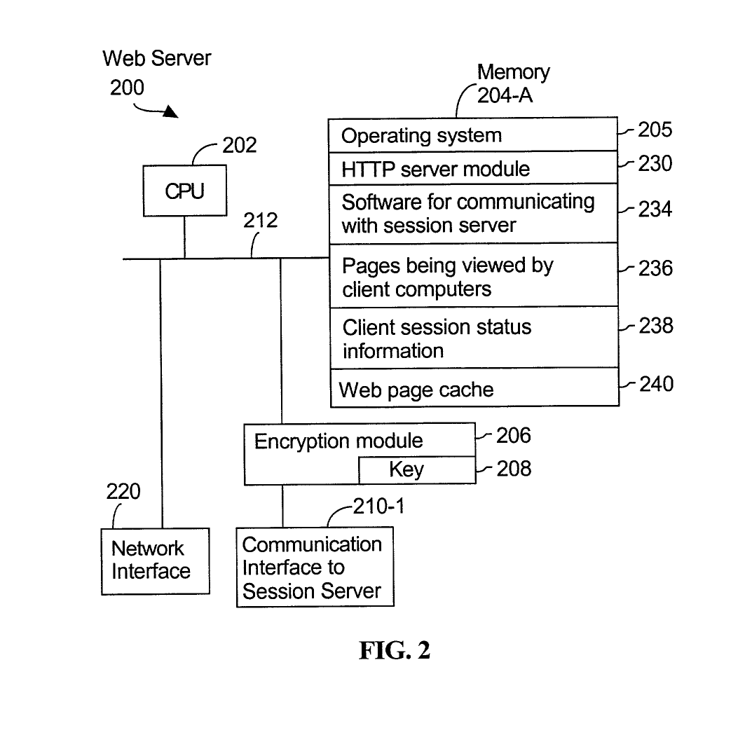

Referring to FIGS. 2 through 8, each of the servers in the system will, in general, include:

a central processing unit 202,

memory 204, which may include random access memory as well as disk storage and other storage media;

an operating system 205, for controlling basic operations of the server;

an encryption module 206 for encrypting messages sent to one or more other servers and decrypting messages received from those other servers, using one or more encryption keys 208;

one or more communication interfaces 210 for exchanging messages with one or more other servers; and

one or more internal communication busses 212 for interconnecting the components of the server.

The back office servers 110, 112, 114, 116 and 400 furthermore all include a private network interface 214 for enabling access to these servers by client computers 126 that are connected to a private network 120. The client computers 126 on the private network are generally used only by trusted employees and agents of the company operating the system 100 for purposes of system maintenance as well as for reviewing and assisting in the processing of the transactions (investment orders) received by the transaction server 110.

It is to be understood that while each of the servers has been described as including certain basic computer system components, all labeled using the same set of reference numbers, these servers may be implemented using computers from a variety of different computer manufacturers, may use different operating systems, and may different from each other in various other ways. Thus, components of the various servers that are identically labeled are not necessarily implemented using identical equipment.

In addition, the encryption keys in some of the servers will differ from the encryption keys 208 in other ones of the servers. For instance each session server includes at least one encryption key for encrypting and decoding communications with the back office servers, and this key is not held by the web servers. Similarly, the back office servers 400, 110, 112, 114, 116 each hold at least one key for encrypting and decoding communications over the private network 120 (also called the back office network), and that key or keys are not held by the session servers 250 and web servers 200.

The relevant distinct aspects of the various servers will be described below.

Referring to FIG. 2, each Web server 200 includes an additional interface 220 for communicating with client computers via the Internet. In one embodiment, the memory 204-A of the Web server includes:

an http server module 230, for handling communications with the client computers 102;

software 234 for handling communications with one of the session servers;

web pages 236 requested by client computers for viewing by customers;

customer session status information 238; and

a cache 240 of static web pages, for instance the static web pages most frequently requested or most recently requested by the client computers 102.

The Web servers 200 are particularly simple because they are configured to forward a very limited set of requests to the session servers 250, and to convey to the client computers of customers the web pages constructed by the session servers.

Referring to FIG. 3, in one embodiment each session server is configured to communicated with just one of the web servers 200. Each session server includes a communication interface 210-2 for communicating with one web server via the first firewall, and another communication interface 210-3 for exchanging requests and information with the transaction, archive, user and web asset servers via the second firewall.

The memory 240-B of each session server 250 preferably stores:

session profiles 260, where each session profile typically includes the current state of one customer's “shopping cart” of investments that the customer has selected, but has not yet submitted as orders, a session key assigned to the “session” (i.e., communications) between a web server 200 and the session server in response to commands by the customer, and information about the most recent web pages composed by the session server for the customer during the current session.

a static web page retrieval module 262 for retrieving static web pages from the web page server 116; the static web pages include informational pages about investments and about the event based investment system as well as informational forms having fields that are populated with information (e.g., customer account information, investment shopping basked information, and so on) requested by a customer, and query forms for obtaining information from a customer, such as investment orders and information needed to update the customer's profile;

a dynamic database retrieval and merger module 264 for retrieving information from the transaction, archive, user and web asset servers and merging it into informational forms to form dynamically constructed web pages; the dynamically constructed web pages are then conveyed to one of the web servers 200 for viewing by a customer at a client computer;

a cache 266 of static web pages, primarily informational pages that are not customer specific, so as to decrease communication traffic between the session server 250 and the web asset server 116.

Referring to FIG. 4, the event server 400 is, in many ways, the primary system (and thus the “brains” of the back office. The event server has three primary jobs: processing customer orders to as to determine what net set of investments to make, executing the investments, and scheduling status transitions in the other back office servers. Each of these tasks will be discussed below.

It should be noted that the event server 400 is not connected to the second fire wall 108 (FIG. 1) and thus is totally inaccessible to the session servers 250. The event server 400 is configured to perform its work even if the web servers and session servers are temporarily disabled by a “denial of service” attack, or other attach on the integrity of those web and/or session servers.

The memory 240-C of the event server 400 preferably stores:

a transaction extraction module 412, for extracting transactions, that is investment orders, from the transaction server;

an archive module 414, for causing the transactions stored in the transaction server 110 to be durably stored by the archive server 112 and deleted from the transaction server 110 upon confirmation of their being durably stored in the archive server;

a pooling module 416 for sorting the investment orders, so as to group the investments in each event based investment and determine a respective net number of investments units;

a security aggregation module 418, aggregating security purchases across event based investments (because there will often be overlap between the securities in the investment units corresponding to the various event based investments), so as to determine a net amount of securities, or corresponding derivative contracts, to purchase;

a trade execution module 420, for executing security purchases and sales, the type and quantity of which are determined by the pooling and security aggregation modules 416, 418; and

a scheduler 422 for performing various schedule based tasks, including enabling and disabling event based investments in accordance with a schedule, archiving transaction information in the archive server, and other tasks.

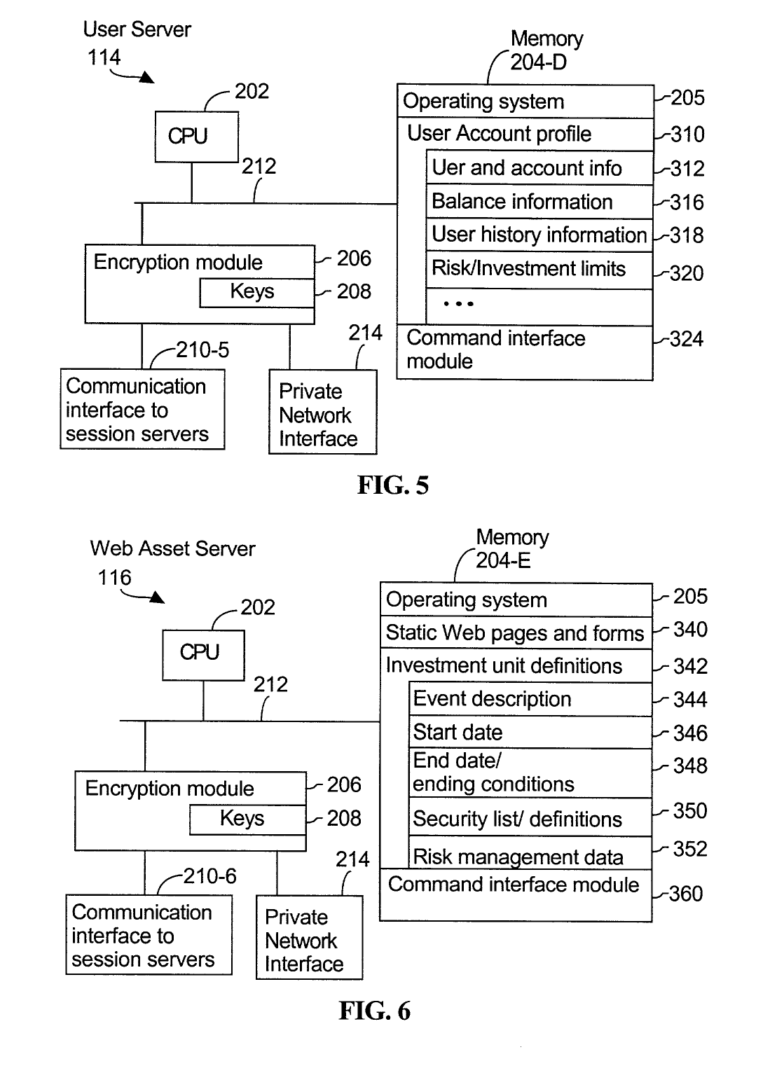

Referring to FIG. 5, in one embodiment the memory 204-D of the user server 114 stores:

user/customer account profiles 310, and

a command interface module 324 for receiving and processing commands from the session servers, the event server and the back office workstations.

In an exemplary embodiment each user profile includes:

user and account identification information 312;

account balance information 316;

user history information 318 (previous and current investments, deposits and withdrawals, investment payouts, etc.); and

risk/investment limits 320 established by the user and/or the company running the investment management system.

Referring to FIG. 6, in one embodiment the memory 204-E of the web asset server 116 stores:

static web pages and forms 340 for retrieval and use by the session servers;

investment unit definitions 342, also for retrieval and use by the session servers; and

a command interface module 360 for receiving and processing commands from the session servers, the event server and the back office workstations.

Each investment unit definitions 342, may include:

an event description 344, describing the event and the associated investment;

information identifying the investment start date and time 346;

information identifying the investment end date and time 348, or the conditions which will determine the investment close;

a security list 350 or other information defining the investment portfolio corresponding to the identified event; and

risk management data 352.

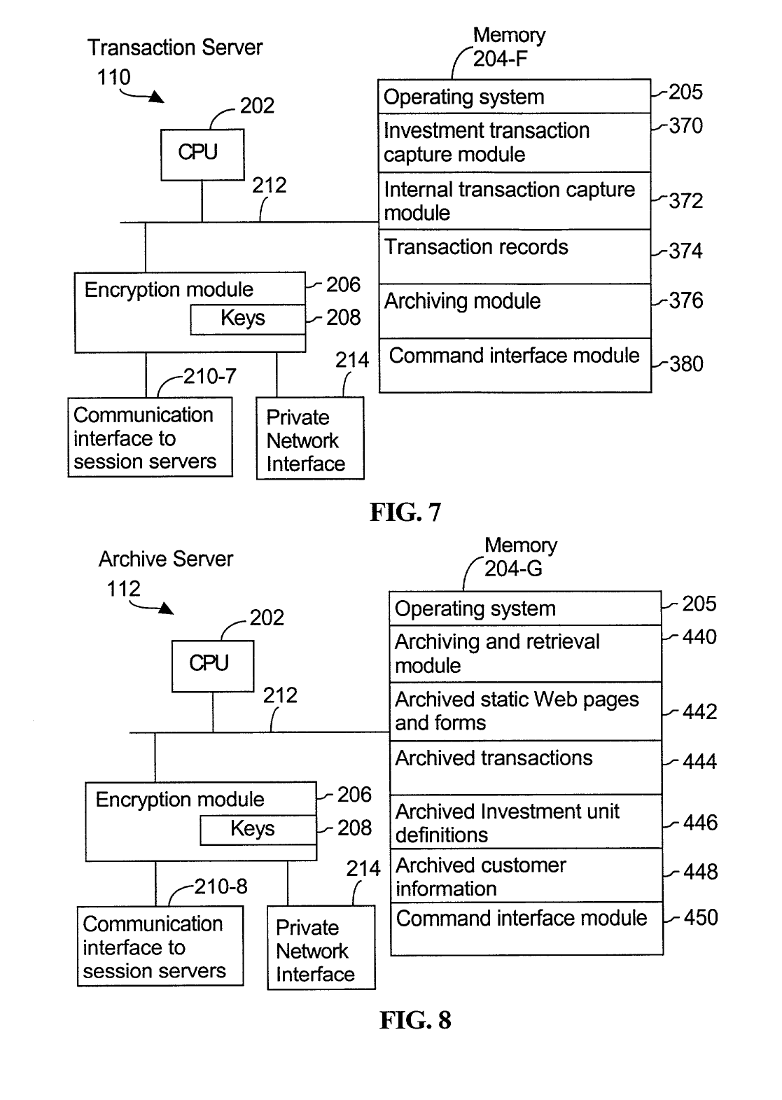

Referring to FIG. 7, in one embodiment the memory 204-F of the transaction server 110 stores:

an investment transaction capture module 370, for receiving and storing investment orders from customers, sent via the web and session servers to the transaction server;

an internal transaction capture module 372, for receiving and storing internal (system) transaction information;

transaction records 374 recorded by the capture modules 370, 372;

an archiving module 376, for transferring the transaction records to the archive server; and

a command interface module 380 for receiving and processing commands from the event server and the back office workstations.

Referring to FIG. 8, in one embodiment the memory 204-F of the archive server 112 stores:

an archiving and retrieval module 440 for storing and retrieving records from the archive database;

archived static web pages and forms 442, stored to enable reconstruction of the static web pages and forms available on the system at any specified date;

archived transactions 444;

archived investment unit definitions 446;

archived user/customer information 448; and

a command interface module 450 for receiving and processing commands from the session servers, the event server and the back office workstations.

It should be noted that the specific configuration of modules described above for the various servers, and the particular division of work between the back office servers may vary considerably from one implementation to another without deviating from the main teachings of the present invention.

In general, the servers and firewalls of the present invention are configured to fully isolate the back office servers (behind the second firewall) from customers as well as persons who may wish to breach the security of the back office. In addition, the system is designed to minimize the work to be performed by event server and thus to move as much of the real time work to be done by servers closer to the users.

Operation of Investment Management System

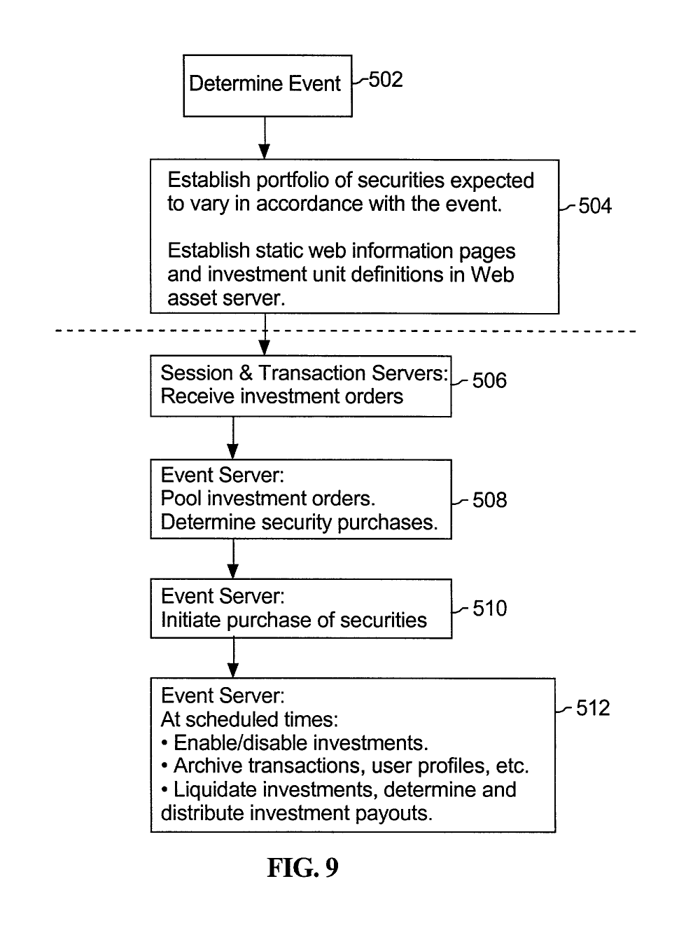

Referring to FIG. 9, for each event based investment there is a event that has been determined (502) to be likely to affect the value of a certain portfolio of securities (504). A corresponding event based investment is defined, and a set of static web information pages describing the event based investment are established. An investment unit definition is also established and stored in the web asset server (504).

Once an event based investment has been established, and trading in the investment has been enabled by the event server, the session and transaction servers receive investment orders corresponding to the event (506).

After the date and time for accepting investment orders for the event based investment has terminated, the event server retrieves and pools the investment orders, and determines the security purchases to be made (508). It should be noted that, typically, some investors will invest based one predicted event outcome while others invest on the opposite (or a different) predicted event outcome, and therefore the investment orders of some investors can typically be balanced by the investment orders of other investors. Furthermore, overlap in the securities of different event based investments may provide further opportunities for aggregation. After determining the investment orders to be made, the event server initiates the purchase of the determined investments (e.g., securities, derivatives, etc.) (510).

The event server furthermore performs various additional tasks at scheduled times (512), including enabling and disabling users from making particular ones of the event based investments; archiving transactions, user profiles and the like; and liquidating investments at the investment close dates and times, and determining and distributing investment payouts to user accounts.

Firewalls and System Security

All communications through the firewalls are encrypted. The use of such encryption helps defeat physical attacks on the system. Even physical access to the back end servers, other than the event server, would be of very limited help to hackers. All the servers preferably include hardware embedded encryption keys and hardware-based encryption modules so as to make security breaches very difficult to achieve. In one embodiment, long symmetric encryption keys are used to encrypt the communications between each server and other servers on the other side of the respective firewalls. The encryption keys are embedded in hardware and are not accessible to the application and operating system modules of the servers so as to prevent an Internet-based (i.e., remote) hostile takeover of a web server from compromising the session servers and the back office servers.

If a Web server is compromised, at most it can retrieve information from its session server, which contains virtually no user information, and even the user information temporarily stored in the session servers is retrievable only using a corresponding session key, thereby severely limiting the user information that may be obtained by any attackers who may succeed in controlling operation of one or more of the web servers.

In the event there is a “denial of service attack” on the system, such an attack will only affect the web servers, and such an attack would have no impact on the execution of orders previously received from customers. In the event that a “denial of service attack” submitted what appeared to be legitimate session requests, the attack might also prevent the session servers 250 from doing any useful work, but the affects of the attack would not impinge on any of the back office servers on the other side of the second firewall.

Each firewall preferably only allows traffic through a single TCP port, a single physical port, and which comes from a single predefined IP address. Furthermore, the second firewall uses different TCP and physical ports than the first, making it virtually impossible for any attack to reach the back office servers. Furthermore, the session servers are configured to make it impossible for any application program, or operation system procedure, to query the hardware of the session servers so as to determine the communication ports being used to communicate with the back office servers.

Alternate Embodiments

The present invention can be implemented as a computer program product that includes a computer program mechanism embedded in a computer readable storage medium. For instance, the computer program product could contain the program modules shown in FIGS. 1-9. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

What is claimed is:

1. A method of event-based investing comprising:
establishing a portfolio of securities having a value that is expected to vary in accordance with possible outcomes of a specific event;
receiving buy orders and sell orders for units of the portfolio;
pooling the buy and sell orders of the portfolio to determine a net number of portfolio units to be bought or sold; and
initiating purchase or sale of a set of securities corresponding to the net number of portfolio units.

2. The method of claim 1, further including
prior to receiving the buy and sell orders, associating an investment commitment date and an investment liquidation date with the specific event;
stopping said receiving of buy and sell orders at a time associated with the investment commitment date;
performing the initiating step at a time associated with the investment commitment date;
initiating liquidation of the set of securities at a time associated with the investment liquidation date, and allocating investment gains and losses to the buy and sell orders.

3. The method of claim 2, wherein the investment liquidation date is no more than one business day later than the investment commitment date.

4. The method of claim 1, wherein the securities are publically traded securities.

5. The method of claim 1, further including monitoring the net number of portfolio units and limiting buy or sell orders so as to limit any imbalance of the buy and sell orders in accordance with predefined criteria.

6. The method of claim 5, wherein the limiting step limits the imbalance to a predefined percentage of a number of orders comprising the greater of the buy orders and sell orders.

7. The method of claim 1, wherein the set of securities whose purchase or sale is initiated includes at least one financial instrument whose value is more volatile than a corresponding set of underlying securities whose value is expected to vary in accordance with the possible outcomes of the specific event.

8. The method of claim 1, wherein the set of securities whose purchase or sale is initiated includes at least one financial instrument whose purpose is to limit financial losses associated with at least one of the buy orders and sell orders.

9. The method of claim 1, wherein the set of securities whose purchase or sale is initiated includes at least one financial instrument whose purpose is to limit changes in value of the portfolio due to an event other than the specific event.

10. A method of event-based investing comprising:
establishing a plurality of portfolios of securities, each portfolio having a value that is expected to vary in accordance with possible outcomes of respective corresponding specific event; wherein the securities in at least one of the portfolios overlaps with the securities in at least another one of the portfolios;
receiving buy orders and sell orders, each order specifying a number of units of one of the portfolios;
pooling the buy and sell orders of the portfolios to determine a net number of units of each of the portfolios to be bought or sold;
aggregating the securities to be bought and sold in accordance with the determined net number of units of the portfolios to be bought or sold so as to determine a respective net number of each of the securities to be bought and sold; and
initiating purchase or sale of the determined respective net numbers of the respective securities.

11. The method of claim 10, further including
prior to receiving the buy and sell orders for each portfolio, associating an investment commitment date and an investment liquidation date with the corresponding specific event;
stopping said receiving of buy and sell orders for each portfolio at a time associated with the corresponding investment commitment date;
performing the initiating step at one or more times associated with the respective investment commitment dates for the respective portfolios in the plurality of portfolios;
initiating liquidation of the set of securities at a time associated with the respective investment liquidation dates for the respective portfolios in the plurality of portfolios, and allocating investment gains and losses to the corresponding buy and sell orders.

12. The method of claim 11, wherein the investment liquidation date for a particular portfolio of the plurality of portfolios is no more than one business day later than the investment commitment date for the particular portfolio.

13. The method of claim 10, further including
monitoring the net number of portfolio units and limiting buy or sell orders so as to limit any imbalance of the buy and sell orders in accordance with predefined criteria.

14. The method of claim 13, wherein the limiting step limits the imbalance to a predefined percentage of a number of orders comprising the greater of the buy orders and sell orders.

15. The method of claim 10, wherein the set of securities whose purchase or sale is initiated includes at least one financial instrument whose value is more volatile than a corresponding set of underlying securities whose value is expected to vary in accordance with the possible outcomes of the specific event.

16. The method of claim 10, wherein the set of securities whose purchase or sale is initiated includes at least one financial instrument whose purpose is to limit financial losses associated with at least one of the buy orders and sell orders.

17. The method of claim 10, wherein the set of securities whose purchase or sale is initiated includes at least one financial instrument whose purpose is to limit changes in value of the portfolio due to an event other than the specific event.

18. A server system, comprising
a first set of servers for exchanging messages with client computers, including receiving buy orders and sell orders for units of a defined portfolio of securities;
a second set of servers for receiving messages from the first set of servers and for integrating dynamic database information with the messages from the first set of servers;
a first firewall for limiting access between said first set of servers and the second set of servers such that each server in the second set of servers can receive messages from only one corresponding server in the first set of servers;
a third set of servers for performing financial transactions in accordance with the buy and sell orders;
a second firewall for limiting access between the second set of servers and the third set of servers so as to permit the third set of servers to receive only predefined requests, and to receive the predefined requests only from the third set of servers.

19. The server system of claim 18, wherein the messages exchanged between the first and second sets of servers are encrypted using a first set of encryption keys, and messages exchanged between the second and third sets of servers are encrypted using a second set of encryption keys distinct from the first set of encryption keys.

20. The server system of claim 18, wherein the first and second set of encryption keys are embedded in hardware within the first, second and third sets of servers and are inaccessible to application programs executing on the first, second and third sets of servers.
